(19) United States
(12) Patent Application Publication
(10) Pub. No.: US 2018/0093420 A1
(43) Pub. Date: Apr. 5, 2018

(54) Calibrated 3-D Printing

(71) Applicant: Modulus 3D LLC, Swampscott, MA (US)

(72) Inventors: George John Roberts, Wellesley, MA (US); Robert Paul Olson, Swampscott, MA (US)

(73) Assignee: Robert Robert Olson

(21) Appl. No.: 15/719,606

(22) Filed: Sep. 29, 2017

Related U.S. Application Data
(60) Provisional application No. 62/402,096, filed on Sep. 30, 2016.

(51) Int. Cl. B29C 64/393; B29C 64/118; B29C 64/209; B33Y 10/00; B33Y 30/00; B33Y 50/02

(52) U.S. Cl. CPC B29C 64/393; B29C 64/118; B33Y 50/02; B33Y 10/00; B33Y 30/00; B29C 64/209

(57) ABSTRACT

New systems and methods for printing extruded materials using a 3-D printer are described. The printing can occur at higher speeds and still maintain the quality found at lower printing speeds. This is achieved by adjusting for the theoretical resistance to flow within the print head.

### CROSS-REFERENCE TO RELATED APPLICATION

This application claims priority to U.S. Provisional Application Ser. No. 62/402,096 filed 30 Sep., 2017, the content of which is incorporated herein by reference in its entirety.

### FIELD OF THE DISCLOSURE

The present disclosure relates to 3-D printing. More particularly, the disclosure exemplifies apparatus, systems and methods to improve 3-D printing by calibrating the 3-D printer based on printed patterns.

### BACKGROUND INFORMATION

Most existing 3D printers are now achieving excellent accuracy and quality but only at slower printing speeds. These printers are moving the extruder at a rate that matches the head velocity. So, in these printers when the head doubles in speed, the extruder doubles in speed because twice as much material needs to be extruded. However, there is an exponential decay between the amount and timing of when the command for the extruder to advance or retract material is given and the time it takes for the material to exit the nozzle. There is also a delay between when the command is sent to the extruder to speed up and slow down and when it exponentially reaches steady state. The result is typically under extrusion when accelerating and over extrusion when decelerating. Although this is adequate for slower speed 3D printing it becomes a problem at higher speeds as the over-and-under extrusion is more pronounced and results in a degradation of print quality and/or loss of detail.

This problem of over-and-under extrusion applies to many different types of 3D printers including those using liquid extrudes, filament extrudes, and paste extrudes. U.S. Pat. No. 6,054,077 describes one method of addressing extrusion by providing an apparatus for extruding a 3-D printed material where the extrusion head is driven at a variable head velocity. However, this method does not sufficiently overcome the problems. (See U.S. Pat. No. 6,547,995).

Thus, there is a need for new solutions to this problem which allows for a higher print quality to be attained when printing at higher speeds using a 3D printing system.

### SUMMARY OF EXEMPLARY EMBODIMENTS

According to at least one embodiment of the invention, there is provided an apparatus comprising a motion control method for a 3D printer. The steps of this method include determining an extruder motor maximum capability for the extruder component, wherein an extruder motor acceleration is never set at higher than the extruder motor maximum capability; determining an extruder motor compensation factor, Kc; and directing the extruder motor to move at a corrected extruder velocity. The corrected extruder motor velocity, V_{NEW}, is defined as

V_{NEW}=Vₙₒₘ+V_{corr}, wherein V_{corr}=A*K_{C}

wherein Vₙₒₘ is the nominal extruder motor velocity, Vcorr is the correction and A is the nominal acceleration of the extruder motor.

In some aspects as described herein, the corrected nozzle velocity profile over time is parabolic. The step of determining the extruder compensation factor comprises obtaining the value from a look-up table or determined based on at least data from a 3D printer nozzle, a filament, and a temperature.

To determine K_{C}, one or more test extrusion patterns (e.g., an “L”-shaped pattern, a grid pattern, an angled pattern, or a straight line printed at more than one speed) having a test velocity profile may be extruded onto a print bed and analyzed. This analysis may be done by a user visually looking at the test extrusion pattern or by analyzing an image. The analysis may include a test, grid, or other template used to help determine actual width of the test extrusion patterns. For example, a template may be added on or under the glass plate on the print bed and comprise parallel lines separated by the width of a quality extrusion. It may alternatively include a comparison against a printed guideline of possible patterns. In some embodiments, K_{C} is determined by computer vision. For example, an image of a test extrusion pattern may be captured by a computer vision system. A computer algorithm may be used in the analysis of the captured extrusion pattern. A quality of the extrusion pattern can be determined based on this analysis. The process of analyzing the test extrusion pattern may be an automated process.

In some embodiments, the corrected extruder velocity is calculated by a processor component. In some embodiments, the extruder maximum capability is determined by the hardware parameters of the 3D printer. A single test extrusion pattern may cover only a small portion of the print bed, or it may cover a large portion of the printing bed. In some embodiments, multiple test extrusion patterns are used and they are scattered over a substantial portion of the printing bed. The one or more test extrusion patterns may be formed at a plurality of speeds, a plurality of temperatures, or both.

Other embodiments include a method for correcting nozzle height position when printing 3D objects comprising: causing a plurality of test extrusion pattern to extrude from a 3D printer nozzle onto a test bed, wherein the plurality of test extrusion pattern are extruded in a plurality of locations around the test bed and wherein the plurality of test extrusion patterns are extruded at one or more commanded heights above the print bed, analyzing, using computer vision, the width of the test extrusion pattern(s) determining the distance between the 3D printer nozzle and the test bed in a plurality of regions, creating a data set comprising differences between the determined distance and the commanded height (height factors) and using the height factors to correct for nozzle height position when printing 3D objects.

Some embodiments include a method that comprises: causing one or more test extrusion patterns to extrude from a 3D printer nozzle, wherein the one or more test extrusion patterns are extruded at a plurality of speeds and a plurality of accelerations, analyzing the one or more test extrusion patterns with computer vision, determining which speed(s) and acceleration(s) were successful and which speed(s) and acceleration(s) exceeded the ability of the extruder motor to cause an extrusion within the parameters necessary for a print, defining a maximum successful extrusion speed and a maximum successful extrusion acceleration as the fastest speed and fastest acceleration that does not exceed the ability of the extruder motor, and using the maximum successful extrusion speed and the maximum successful extrusion acceleration to limit the speed and acceleration of the extruder. The test extrusion patterns may be extruded at speeds and accelerations that are increasing. In some embodiments, the test extrusion patterns are extruded at a variety of speeds, including speed(s) and/or acceleration(s) that are expected to be above the speed and/or acceleration at which the extruder can extrude. The test extrusion patterns may be extruded at increasing speeds or accelerations until the test extrusion pattern no longer has sufficient quality (e.g., the line width varies). Thus, later prints can be kept below this speed or acceleration.

Yet other embodiments include a method comprising: causing one or more test extrusion patterns to extrude from a 3D printer nozzle in a first direction, causing one or more test extrusion patterns to extrude from a 3D printer nozzle in a second direction that is substantially opposite from the first direction, along an axis and where each pattern ends with a visual mark such as a corner, analyzing the one or more test extrusion patterns with computer vision, determining if backlash is causing the marks not be at the commanded position and the distance of error in these marks can be saved as a backlash distance for said axis and where this measured backlash distance can be corrected for during normal printing.

Some embodiments include a method comprising: causing two or more test extrusion patterns to extrude from a 3D printer nozzle, wherein the test extrusion patterns are lines that are substantially perpendicular to each other, measuring the angle between the two or more test extrusion patterns using computer vision, and correcting skew for errors in perpendicularity based on the measured angle.

Yet other embodiments include a method of hardware alignment comprising printing a grid or other test extrusion pattern with extrudate and analyzing it to correct for nonlinearities in the motors that move the nozzle through space and/or to calibrate distances between multiple nozzles for printers having more than one nozzle.

Another aspect of the invention comprises a 3D printing apparatus comprises an extruder component that comprises a movable nozzle, an extruder motor that is configured to control an extrusion amount, a processor configured to perform the steps as provided above.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF DRAWINGS

Further objects, features and advantages of the present disclosure will become apparent from the following detailed description when taken in conjunction with the accompanying figures showing illustrative embodiments of the present disclosure.

FIG. 1(A) shows an exemplary printed shape under ideal conditions.

FIG. 1(B) shows an exemplary printed shape under conditions of over extrusion and under extrusion.

FIG. 2 shows an idealized model of a 3D printer.

FIG. 3 shows a theoretical velocity profile.

FIG. 4 shows a velocity profile of nominal and compensated extruder velocities over time

FIG. 5 shows exemplary printed patterns which are underextruded, properly extruded, and overextruded.

FIG. 6(A) shows an example pattern of extruded material. FIG. 6(B) shows an exemplary pattern.

FIG. 7 is a diagram showing movement on the X and Y axis.

FIG. 8 is a flow chart showing the steps in an exemplary 3D printing process.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION OF EXEMPLARY EMBODIMENTS

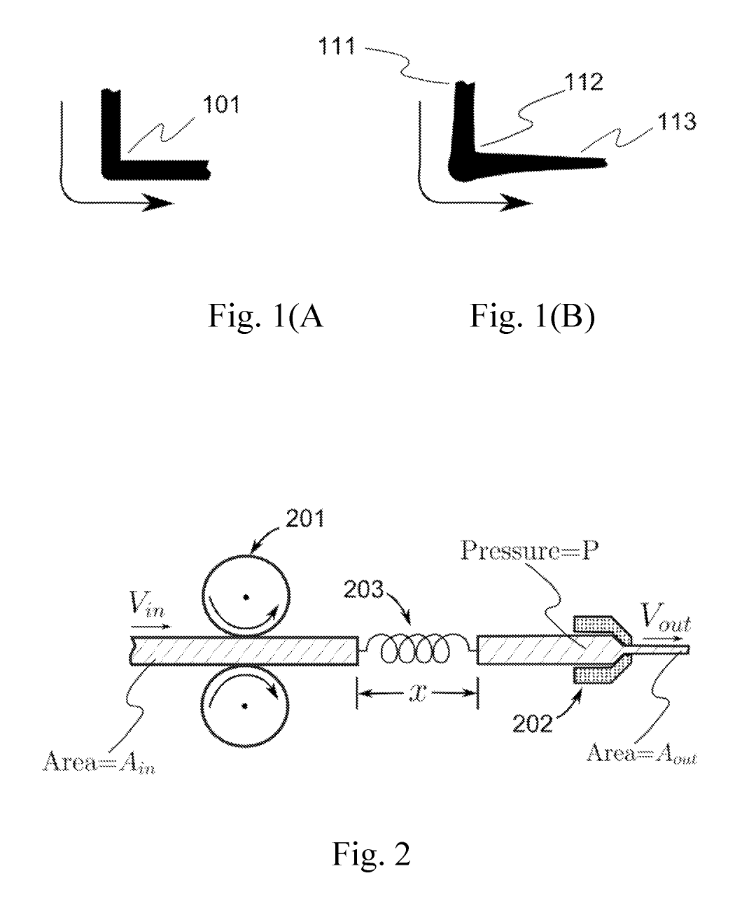

In extrusion printing, when printing at very slow speeds, the printer doesn't have to slow down for corners or vertexes in order to attain a good extrusion result. An example is the printed shape A shown in FIG. 1(A). This top plane view of shape A represents one layer of extrusion near a vertex 101. The arrow indicates direction of travel for the printer head. The width of the trace in example shape A is correlated to the diameter of the extruding nozzle. The vertex 101 happens to be 90 degrees in shape A in FIG. 1(A), however, it could be 80, 70, 60, etc. degrees. As the angle for 101 becomes more acute the printing speed of the 3D printer will need to be reduced in order to achieve a high print quality. Note that in this exemplary drawing, the outer curve shape of bend 101 is indicative of shapes made using a circular nozzle so the nozzle radius is evident in the outer curve of bend 101.

When printing at higher speeds or any printing where a stepper motor must change speeds quickly, as shown in the printed shape (B) of FIG. 1(B), the extruded form has varying line width and often is out of the tolerance necessary for the particular application. In region 111, there is an equilibrium between the printer head speed and extruder speed, so the extrudate extrudes at the correct rate, but as the nozzle approaches the vertex 112, over-extrusion occurs. The over-extrusion is due to the pressure in the nozzle forcing out more material than is needed to attain the same width as 111 while the head is moving slower to print vertex 112. At the vertex of 112 the overextrusion is at its maximum. Then as the head accelerates out of the vertex, proper extrusion and proper line width is achieved momentarily but is quickly followed by a gradual underextrusion 113 as the nozzle accelerates faster than the printing material can be extruded from the printing head. In extreme cases where the acceleration of the printing head is faster than the extruder nothing is extruded for part of the printed trace and a gap occurs in the printed object resulting in a poor-quality print. Eventually equilibrium is again reached and the width size of 111 is attained. The process repeats the next time the nozzle has to slow down for a vertex and the same over-under-extrusion problems occur. The result is a poor quality print at higher print speeds.

To compensate for this over-extrusion and under-extrusion, pressure compensation can be used. FIG. 2 shows an idealized model of 3d printing where the spinning circles 201 represent feeder control such as a plunger extruder or a filament feeder with precision control. Printing material 204 (e.g., filament, gel, paste, etc,) is fed through the feeder control 201, where the region 203, shown as a spring, represents the compressibility of the printing material 204 along the path between the feeder control 201 and nozzle 202. The nozzle 202 is part of an extrusion component (not shown) which may contain, for example, a heater element and is the point where the area changes and may be a nozzle, heat chamber entrance, needle, or other change in area where fluid or paste experiences friction and significant pressure change occur. As shown in FIG. 2, the area for the printing material 204 is reduced at the nozzle 202 causing increased pressure compared to outside the nozzle 202.

Region 203 represents a number of additional spring like factors such as a bowden tube or the walls of an extruder or the pushing element of a plunger, etc. Vᵢₙ represents the velocity of the printing material (extrudate) with cross sectional area Aᵢₙ. Vₒᵤₜ represents the velocity of the printing material as it exits the nozzle 202 or needle etc with a cross sectional area of Aₒᵤₜ. Δx is the amount that x is compressed or reduced due to force or pressure on the material. It also represents the amount of extra material feeding needed in order to get the desired output.

A goal is to calculate how much extra needs to be added to Vᵢₙ over nominal/standard 3D printing to compensate for the spring like action that causes an apparent delay between when the feeder 201 is commanded to extrude and when filament comes out of the nozzle 202.

While not wishing to be bound by theory, this can be understood by starting with the ideal spring formula. This equation gives us:

F=−xKₛ (1)

where Kₛ is the spring constant. Since we define Δx is the decrease in x caused by force then we can rewrite equ. (1) as:

F=ΔxKₛ (2)

where F is the force coming from the feeder 201. Since pressure is force/area:

P=F/Aᵢₙ (3)

Combining equations (2) and (3) we get:

$$P = \frac{Δ {xK}_{s}}{{A}_{i n}} \qquad ( 4 )$$

Now the friction through 202 can be modeled using Darcy-Weisbach equations of fluid through a pipe as:

Vₒᵤₜ=C₁P/μ (5)

Where C₁ is a constant based on shape of the nozzle 202 and μ is the viscosity of the liquid. Substituting P in equation (5) using equation (4) we get:

Vₒᵤₜ=C₂Δx/Aᵢₙ (6)

Where C₂ is a constant combining C₁, Kₛ and μ. Solving for Δx we get:

Δx=C₃VₒᵤₜAᵢₙ (7)

Where C3 is 1/C2. Taking the derivative versus time we get:

$$\frac{d Δ x}{dt} = {C}_{3} \frac{{dV}_{out}}{dt} {A}_{i n} \qquad ( 8 )$$

The derivative of Vₒᵤₜ versus time is the acceleration of the extruded liquid, Accₒᵤₜ. The derivative of Δx is the added velocity we need to add to Vᵢₙ also known as “pressure compensation” to compensate for spring-like effects. Also, we can combine Aᵢₙ with C₃ to make another constant. So, we rewrite equation (8) as:

V_{in(comp)}=C₄Accₒᵤₜ (9)

This is understood since, as you are printing at a constant velocity for a long time the acceleration should be zero and no compensation is needed. In other words, eventually the pressure P builds up to a steady state. It's the change in velocity (acceleration) that causes problems with over extrusion and underextrusion. Because this is the extra velocity needed over nominal velocity, Accₒᵤₜ will be proportional to nominal acceleration in based on Aᵢₙ divided by Aₒᵤₜ which is yet another constant (Aₙₒₘ) so we can write our pressure compensation equation as:

V_{NEW}=Vₙₒₘ+Aₙₒₘ*K_{C} (10)

wherein, defining a correction velocity Vcorr as Aₙₒₘ K_{C}, this can similarly be described as:

V_{NEW}=Vₙₒₘ+V_{corr}

where V_{NEW} is corrected extruder velocity, Vₙₒₘ is the nominal extruder velocity, Aₙₒₘ is the nomimal extruder acceleration (before correction is added), and K_{C} is our compensation factor

Note that the compensation factor, which is constant K_{C} depends on many factors including the type of printing material, viscosity, nozzle shape and a spring factor that will roughly double K_{C} value if you double the length of a bowden tube (for bowden printers). For paste extruders K_{C} value could get smaller depending on the position of a paste plunger because the side walls of a paste holding cylinder, if flexible, will raise the K_{C} value as the volume shrinks before the paste exits the nozzle or needle. Viscosity changes depending on filament temperature (for filament extruders), type and even color. Thus, the value of K_{C} may be different for every printing material, temperature change, filament color change and nozzle change. However, in some instances, the value of Kc will be substantially constant during use of a 3D printer, particularly since a similar material, filament, nozzle, and temperature are used for multiple prints.

In some embodiments, the compensation factor as calculated could be too severe such that normal motors could not accelerate at the rate described by the compensation factor. Thus, to keep the E axis within it's maximum acceleration parameters, the jerk of the XY axes should be reduced. Thus, by increasing the acceleration gradually on the XY axes, there will be a delay in how long it takes to get up to full speed, but the motion planner will not be directed to accelerate beyond its capacity. Higher quality and overall faster speeds can be accomplished.

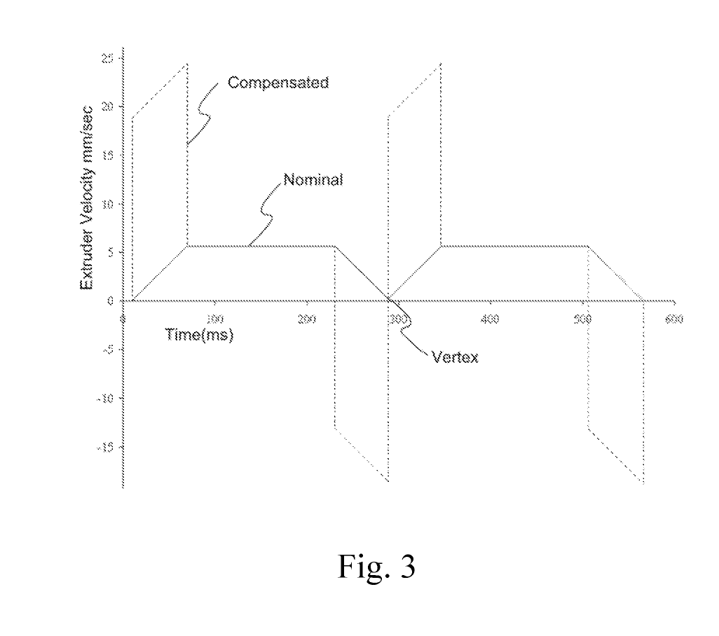

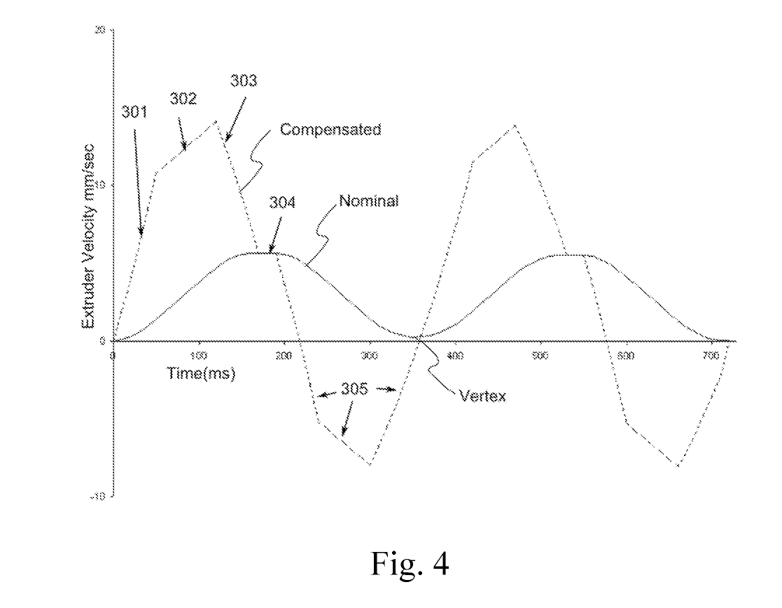

A typical existing motion planner used during a 3D printing process takes commanded head positions and extrusion amounts as a series of gcodes which only control the line segments to be printed in X, Y, Z, E space (E controls extruder distance) and also a requested velocity for all movements. The motion planner is designed to take into consideration the limitations of the printer and typically has to slow down the motion on sharp corners to keep from exceeding the capability of the controlling motors (typically steppers). The motion for each line segment to be printed typically makes a trapezoidal graph when plotted velocity versus time. The slope of the graph is acceleration which is usually a constant in typical motion planners (e.g. Marlin, Repetier 3d printer firmware). FIG. 3 shows a two-segment movement. In one exemplary embodiment, an Ultimaker™ printer was used, where the speed was set to 300 mm/sec, acceleration 5000 mm/sec, filament 2.85 mm diameter, layer height 0.3 mm, nozzle diameter 0.4 mm. For this example, K_{C}=0.2 Sec. However, for these parameters, K_{C}=1 was experimentally found to be optimal. Unfortunately if K_{C} is increased to 1.0, this results in extruder speeds a bit more than double the extruder maximum capability of this machine (which could be fixed by dropping the acceleration to 2500 mm/sec) but also the acceleration is infinite. Note the point labeled “vertex” where the head slows down to 14 mm/sec (extruder at 19 mm/sec) as it rounds a sharp corner. The extruder is expected to go from −18 mm/sec to +19 mm/sec in under 1 ms. Normal extruders on typical 3d printers can't do this let alone with Kc=1 it would have to go to five times these speeds (about −100 mm/sec to +100 mm/sec in 1 ms). The solution is to achieve a non-trapezoidal graph when plotting velocity vs time and is exemplified by FIG. 4.

Thus, the extruder velocity profile may be parabolic over time, such as shown in FIG. 4. As used herein, the term “parabolic” is not limited to a precise or mathematical parabolic profile. The parabolic velocity profile looks mostly parabolic as compared to the trapezoidal shaped velocity profile used for many prior motion control methods (e.g., as shown in FIG. 3). The extruder motor may have continuous speed control. This continuous speed control allows for small changes in speed to provide a profile such as shown in FIG. 4. The ability to move the motor at variable speeds can allow for improved prints.

The present invention includes a motion control method where the extruder motor is directed to move at a corrected extruder velocity. The corrected extruder velocity is based on a nominal extruder velocity combined with a correction factor where the correction factor is the nominal extruder acceleration multiplied by K_{c}. Thus, the extruder motor is moved at nominal printing velocity which is a constant times head velocity but where a constant times head acceleration is added to this velocity to compensate for varying pressure in the nozzle which results in more exacting extrusion amounts exiting the nozzle during the extrusion. The change in acceleration (i.e., jerk) of the print head is kept below a certain maximum such that the extruder never accelerates beyond its maximum capabilities.

Thus, this method can be further understood by considering it as changing the acceleration gradually and using a constant jerk instead of a constant acceleration (acceleration is derivative of speed and jerk is the derivative of acceleration). As shown in FIG. 3, this provides similar parameters as shown in FIG. 2 except acceleration is limited to 2500 mm/sec and changed gradually (jerk is kept below 50 meters/sec³). Instead of a trapezoid, FIG. 3 provides a slowly increasing head acceleration resulting in a mostly constant acceleration for the extruder 301 followed by a constant head acceleration section (2500 mm/sec²) 302 where the slope matches the nominal curve below followed by negative jerk section 303 where acceleration is decreasing followed by a constant head velocity section 304 where no extruder compensation is needed. Note also that for the deceleration portions the extruder velocity typically goes negative 305. This automatically also takes care of most of the retraction needed as by the time the head stops the pressure should be almost zero and the actual extrusion should be close to zero. By limiting acceleration and jerk, it is possible to print at very high velocities and still keep up with a typical extruder motor. Note that the total time to print both segments in one exemplary embodiment is only about 25% slower than in FIG. 3. It may be 25% slower than the previous example but the quality is as good as prints that don't use this technique that were made at speeds 5 times slower.

### Determining K_{C}

The extruder compensation factor K_{C} may be determined via one of a number of methods. For example, K_{C} may be provided in a look-up table. The constant may be provided, for example, for each different 3D printer, filament, and extruder component properties. Extruder properties such as nozzle shape and type. Paste extruder properties such as paste cylinder flexibility and diameter. Needle extruder properties such as needle length and inside diameter. Filament viscosity which can be affected by chemical composition, color additives, temperature and humidity.

Another method of determining the value for K_{C} is based on visual inspection of the resulting prints. A series of prints are made at a desired print speed of a calibration shape and the result of the printed calibration shapes are used to help determine Kc. Each time the calibration shape is printed, the value for Kc may be changed. Several calibration shapes can be printed with varying values for K_{C} and the best resulting print as determined visually is selected. The printed calibration shape may be only a single layer (e.g., a layer formed directly on the print bed) but may alternatively include several layers or more if needed to determine the best value for Kc. In some embodiments, the print material has a high contrast with the print bed.

For example, the best resulting print, which can be the one with the most consistent line width throughout the entire printed calibration shape. For example, in FIG. Y the dotted lines show the widths that would be measure with a ruler or template to determine that the line widths are all the same value within a reasonable error range. These error ranges can be obtained, for example, from a table based on the print head size used.

When defining the quality of the test extrusion pattern, having a constant or near constant width is important, and particularly so at the acceleration phase (e.g., at the start of a line in a test extrusion pattern). The width can be determined, for example, by simply looking at the test extrusion pattern or by viewing an image of the test extrusion pattern. In some embodiments, a grid can be placed under or on the print bed and the test extrusion pattern(s) can be printed on top of the grid. With this in place, it can be simpler to see the line width and any variation in the width. In some embodiments, either with or without the grid, the width of the lines and variations therein are obtained through computer vision.

With K_{C} equal to zero you would expect a print result like FIG. 1(A). As you increase the value of K_{C} you get closer to a shape like FIG. 1(B). If K_{C} is too large you get the opposite of when K_{C} is too small. So, when K_{C} is too large you would get underextrusion at the corner and just before the corner and you would get overextrusion in the region of 113.

In some embodiments the calibration shape includes a long line that is printed quickly and then a short slow segment, for example 500 mm/sec for the fast segment and 10 mm/sec on the slow segment. If K_{C} is too small the short segment will be overextruded and if K_{C} is too large the short segment will be underextruded. One can print several of these repeating with different values of K_{C} and select the K_{C} value used for the best corner.

In some embodiments, KC is determined via an automated computer vision calibration. This process of determining the best K_{C} can be automated using, for example, a digital camera or cameras. The camera may be mounted in the 3D printer facing downwards so that it can image the calibration shape formed on the print bed. A test extrusion pattern can be printed as described above and the best value for K_{C} can be chosen automatically by measuring the widths of the traces of printed material based on the digital image, where the highest quality test extrusion pattern is the one having the best value of K_{C}.

This calibration process is preferably to be done every time a nozzle is swapped for one with different geometry, any time the viscosity changes (e.g., a different printing material is used, a different temperature is used to print the material, or anything else that affects viscosity.) In some instances, changing the color of a filament printing material will change the viscosity.

An additional advantage of using automated computer vision calibration is that the camera or cameras used for the computer vision system may also be used for additional methods and processes during the 3D printing.

In some embodiments, it is important to standardize the width of the lines being analyzed. An exemplary way to standardize the width is to use a printed template placed under or printed on the build plate that has a series of line widths and patterns based on the size of the nozzle or nozzles being used.

In some embodiments, it will be important to first test how sensitive the visual system is to picking up small changes to the width of the line being printed and to optimize the accuracy enough to result in a consistently good print. One method for optimization is in camera placement. In the various embodiment involving computer vision as described herein, a camera is placed on or near the 3D printer. The specific location of the camera is not limiting, however, it should be placed so it can image the test extrusion patterns printed on the print bed. Exemplary locations include at a corner of the 3D printer at the height of the nozzle. Other embodiments include a camera on or near the extruder component. The actual location can be optimized to improve visualization of the test extrusion patterns and thus the sensitivity of the visual system.

Leveling the print bed can be important in 3D printing to ensure a high-quality print result. It's often done manually with 3 leveling points or screws to adjust the print bed parallel with the nozzle control gantry. Some printers have an auto leveling system that can measure the bed using for example a capacitive sensor near the nozzle, or a switch or a hall effect sensor that can detect the distance to the bed. The bed is probed at a minimum of 3 locations but sometimes dozens of locations. The measured height of the bed at every point is typically stored in an array to be used later for height correction or height compensation when printing.

In some instances, a camera is included in a 3D printer. The camera is part of a computer vision system installed with the 3D printer which allows for the visual capture and analysis of printed materials. The computer vision system along with the embodiments discussed previously can be used to attain the fastest speed possible for the 3D printer while keeping a high quality for the printed material.

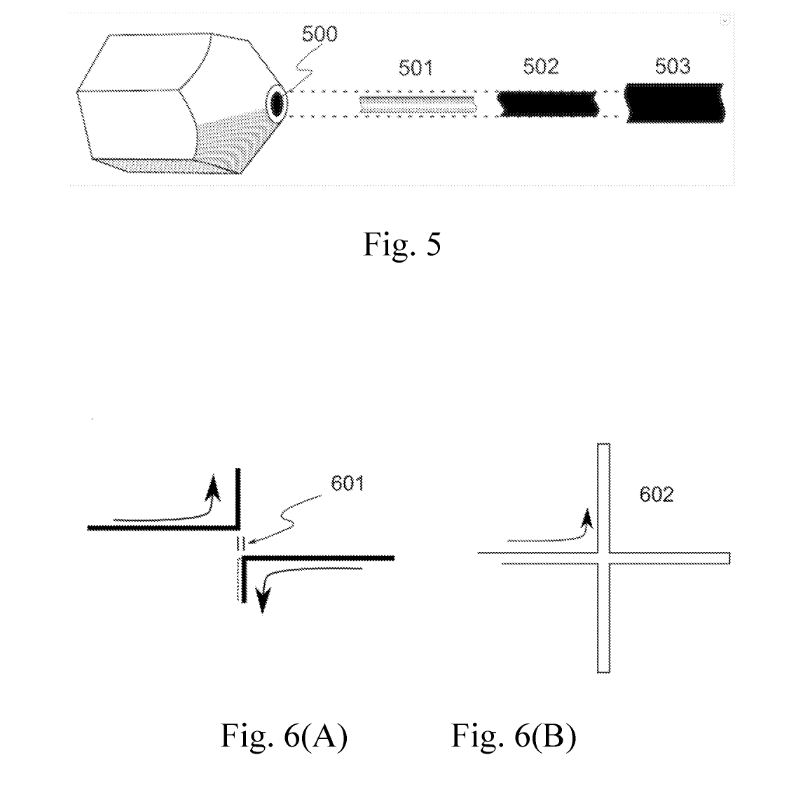

Using the computer vison system, it can be easy to carry out a leveling procedure by extruding a test pattern onto the bed and capturing the pattern for analysis. One or more patterns can be printed and one or more points of data in regards to the patterns can be stored into an array to assist in the proper adjustment of the extruder nozzle height at many positions. Using this method, it is possible to measure the thickness of the printed pattern at many points. FIG. 5 illustrates an example of what a pattern looks like if the nozzle height is too far above the bed 501, at the desired height 502, or height too close to the bed 503. When the nozzle is at the desired height 502 the width of the extrudate matches the diameter of the nozzle 500. When the nozzle is too high above the bed the extrudate bead 501 is thinner than nominal and looks ropy. When the head is too close to the bed the extrudate bead 503 is thicker than nominal and can also be more transparent.

From this information one can get approximate leveling compensation factors for every point where a test extrusion pattern was printed. If furthermore the test extrusion pattern was printed purposefully at several heights one can increase this accuracy. The test extrusion pattern that looks most like 502 was the pattern printed at the perfect printing height. That height then gets stored into the height compensation array for that region of the print surface.

The process of utilizing this array of heights is well established in firmware such as Redeem. The firmware (or alternatively software) moves the nozzle up and down to match these heights as it prints the bottom most layer. Heights at coordinates between the heights in the array are interpolated. Less and less compensation is then used on each successive layer and at some point (configurable in Redeem) no more compensation is applied.

In other embodiments, edge detection algorithms and/or other processing algorithms can be used to define the parameters of the test extrusion pattern and the edge location is displayed or analyzed.

Some printers use pulleys in the X and Y axis movement that are rotating around an axis that is slightly (incorrectly) offset from the mechanical center of the pulley resulting in a repeating nonlinear pattern. Other nonlinearities in the X and Y axis of a printer can occur. A test extrusion pattern can be drawn with extruded material automatically and then the test patter can be analyzed via a computer vision system. By looking at the spacing between lines in the grid a computer vision system can store the amounts of nonlinearity in the X and Y axes for each area of the print bed and make adjustments to make the print result linear. In some embodiments, the compensation comprises an operation on the gcode values before they reach the main motion planning code.

In some embodiments, the present methods also include the extruder speed limit and acceleration limit calibration. To be able to print faster and attain a high print quality, as described earlier, we need to run the extruder to near its limit. Since not all extruders have the same top extrusions speeds due to various factors, such as wear and tear due to use, it is important to be able to measure the top speed for the extruder being used. Typically for stepper motors if you command too high of a speed or acceleration they extrude nothing. Other types of extruders may simply reach a limit where they are not extruding more when acceleration or speed is increased beyond a certain point.

A computer vision system can be used to determine if a printed line is extruded at the nominal extrusion 502 or is underextruding 501. Thus, by increasing the speed of the extruder over a series of prints until the printed results are different from the ideal extrusion standard 502 a top speed can be determined for the extrusion system being tested.

Once we have leveled the bed using a printed pattern made at slow speeds we can now look for the same patterns in FIG. 5 again where 501 is underextrusion, 502 is nominal extrusion. As you print with higher velocities and higher accelerations for the extruder of course you also would most likely print with higher nozzle velocities across the bed such that if the extruder can keep up you would get a pattern like 502 but eventually the extruder systems capabilities will be exceeded and the resulting printed pattern will look like 501 where the extrudate bead is thinner than the nozzle diameter.

For example, a test extrusion pattern may be printed multiple times, each time increasing the speed by 5, 10, 20, etc. mm/sec and also patterns with increasing acceleration for example 200,400,800,1600 mm/sec/sec. These test extrusion patterns are then analyzed by computer vision to determine when the 3D printer fails to print the predefined amount for the test extrusion pattern. The extruder speed just below this point is the maximum capacity. Or one can multiply by a safety factor, for example set the maximum extruder velocity to half the value that the pattern showed was possible and for example set the maximum extruder acceleration to 75% of that which was achieved in the pattern. Thus, the extruders maximum capacity may be determined or tested via this method. We can use these values to keep the extruder from ever exceeding these max rates which may change over time and may change depending on the viscosity of the material and the shape of the nozzle (mostly the nozzle diameter and length). However, in other embodiments, the extruder maximum capacity is defined by parameters set by the 3D printer manufacture or by other means.

Many printers have backlash (also known as “play”) in the print head. Thus, if you approach a point from one direction and then later approach the same point from the other direction the print head doesn't reach the same position. This play can be caused by, for example, loose belts, gears not completely meshing, or belts that stretch a little combined with high friction, or just parts of a printer that are flexible or loose. There are known ways of compensating for this backlash in 3D printer firmware such as Redeem. However, these compensation methods generally require knowing the backlash distance first. In contrast, in some aspects of the invention described herein, an automatic backlash calibration may be realized. Determining the compensation distance to use for X or Y axis can be determined, for example, with a digital camera. One example pattern is shown in FIG. 6(A) where the thick black lines indicate what the extruded material looks like from overhead and the arrows show the direction of travel as it was laid down. The dotted line represents the trace if there was no backlash. The distance between the two lines at 601 represents the amount of left/right backlash. A video computer system can measure this distance 601. The key portion of the pattern is that a location is reached from two different directions. Similarly rotate the pattern 90 degrees to measure Y axis backlash. The pattern 602 shown in FIG. 6(B) shows a pattern that can be used to measure both X and Y backlash using a single pattern. Thus, the present invention also provides for determining backlash in a print head system. Further, because the backlash can be defined, the present invention also provides compensating for the backlash during the printing process.

In some embodiments, the present invention also provides automatic skew calculations. Sometimes in 3D printing, the control structure that moves the nozzle in X and Y is skewed such that the axes are not perpendicular and are beyond nominal tolerances.

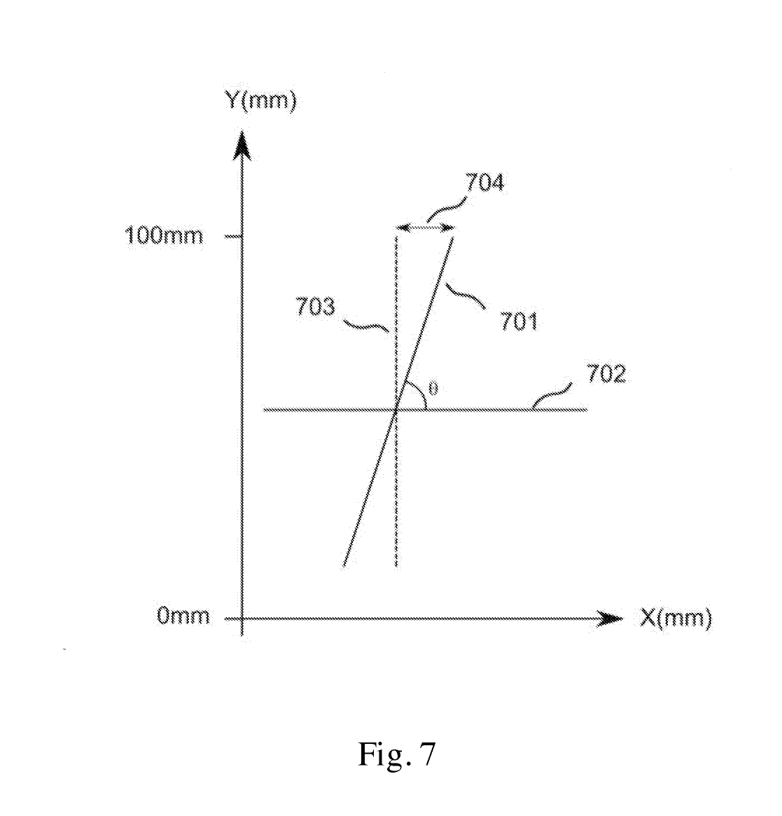

Using a test extrusion pattern such as the test extrusion pattern 602 in FIG. 6, or the exemplary pattern in FIG. 7 below the horizontal and vertical lines can be analyzed with, for example, a digital camera. Where the lines are found to be out of tolerance (e.g., not perpendicular), the skew can be compensated for when printing. In some embodiments, the compensation comprises an operation on the gcode values before they reach the main motion planning code. More specifically in FIGS. 7, 701 and 702 denote an extrudate pattern as seen from above. Line 701 has an error from the expected pattern denoted by the dashed line 703 such that the angle is not the expected 90 degrees. The skew can be stored in at least 2 methods. The first method stores a skew error 704 (which is the X error distance) for many Y values in an array. 704 denotes the skew error for Y position 100 mm. All of the skews for each Y value could be stored in an array and that skew could be subtracted from every X coordinate using said array. For example, array position 100 (for 100 mm) might have the measured skew value of 3 mm. Array position 99 might have the measured skew value of 2.8 mm and so on. For Y values in between the array positions the value could be linearly interpolated. Alternatively, a single slope could be stored. If the skew at Y position 100 is 3 mm and the skew at Y position 0 is −3 mm then the slope would be 6/100 or 0.06. Now the firmware can simply take all incoming X and Y gcode positions, multiply the Y value by the slope (0.06) and subtract this skew correction from the X value. There are many other ways to store the skew errors. An alternative way that gives the same result would be where the X values could be compensated based on Y position.

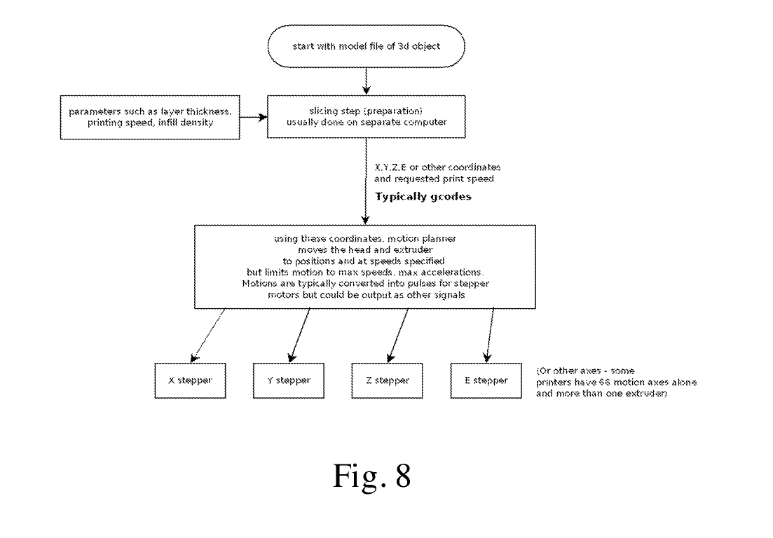

FIG. 8 provides an exemplary process for 3D printing using the apparatus or process as described herein.

An example of a 3D printing process is provided herewith. Initially, the parameters of a print are defined and, generally, a CAD program output a 3d representation of the part—typically as an STL file which contains triangles in 3d space. This information is sent to a slicer, such as Cura. The slicer intersects a plane with these triangles and for each slice/layer gets a bunch of line segments (plane intersecting a triangle is a line). These randomly ordered line segments are ordered into loops, it figures inside from outside, adjusts for nozzle radius and outputs gcodes. The gcodes are sent to the printer and a firware portion of the 3D printer directs movement (for example, by moving it's stepper motors) according to the gcodes. The gcodes include, for example, are X, Y, Z, E (E=extruder) coordinates in 4-dimensional space. Plus, an occasional feedrate (F). The movement may be movement of the extruder component, the base plate, or a combination thereof. Additionally, the 3D printer directs extrusion of an extrudate through the extrusion component during the movement. Generally, the movement is linear in all axes including extruder due to the acceleration phase. For example, X and E are accelerated for an equal portion of the line segment and equal time. In some embodiments, the motion in all axes is linear or proportional.

The extruder motor provides movement of the nozzle or alternatively the entire extruder component (which may further include additional nozzle(s), heater elements, etc.). The extruder motor may be a motor configured to drive a Bowden tube or a paste extruder, or may alternatively include a mechanism for pressing air and a valve. The nozzle may be a nozzle similar to the one shown in FIG. 5 or, in other embodiments may be different and configured for extrusion of, for example, plastic filament, metal filament, paste, epoxy, or food (e.g., chocolate).

Often, the firmware provides settings for both a maximum velocity and a maximum acceleration capability. The motion control should not exceed these values.

In use, for example the firmware decides an exact movement profile for a single gcode and calculates the total number of steps to move each axis. It will define a starting overall velocity, a peak velocity, an ending velocity as it ends its segment, how long and how fast to accelerate and decelerate. The movement profile can have up to 3 sections: accelerate, plateau (constant speed), decelerate. Some of these may be of zero length (e.g. no acceleration, no plateau, no deceleration or 2 of these may be missing) but it will always do them in this order.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., stepper drivers, firmware, fan controller(s), temperature controller(s) and probes, power circuits, and other application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more motors, fans, thermometers, circuits to control endstops, or circuits to perform the functions of one or more of the above-described embodiment(s). The stepper drivers, firmware, etc, may all be on the same circuit board, on two (or more) boards that are physically attached to each other, or on additional boards either attached or separated.

The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a cloud, a hard disk, a random-access memory (RAM), a read only memory (ROM), a storage of distributed computing systems, an optical disk, a flash memory device, a memory card, and the like. An I/O interface can be used to provide communication interfaces to input and output devices, which may include a display, a keyboard, a display, a mouse, a touch screen, touchless interface (e.g., a gesture recognition device) a light pen, an optical storage device, a scanner, a microphone, a camera, a drive, communication cable and a network (either wired or wireless).

In referring to the description, specific details are set forth in order to provide a thorough understanding of the examples disclosed. In other instances, well-known methods, procedures, components and circuits have not been described in detail as not to unnecessarily lengthen the present disclosure.

The term “about,” as used herein means, for example, within 10%, within 5%, or less. In some embodiments, the term “about” may mean within measurement error. The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. A motion control method for a 3D printer, the 3D printer having an extruder component that comprises a movable nozzle and where an extrusion amount is controllable via an extruder motor, the method comprising:
determining an extruder motor maximum capability for the extruder component,
wherein an extruder motor acceleration is never set at higher than the extruder motor maximum capability,
determining an extruder motor compensation factor, K_{c}, and
directing the extruder motor to move at a corrected extruder velocity,
wherein the corrected extruder motor velocity, V_{NEW}, is defined as
V_{NEW}=Vₙₒₘ+V_{corr}, wherein V_{corr}=A*K_{C}
wherein Vₙₒₘ is the nominal extruder motor velocity, Vcorr is the correction and A is the nominal acceleration of the extruder motor.

2. The method of claim 1, wherein the corrected nozzle velocity profile over time is parabolic.

3. The method of claim 1, wherein determining the extruder compensation factor comprises obtaining the value from a look-up table.

4. The method of claim 3, wherein the value for the extruder compensation factor is determined based on at least data from a 3D printer nozzle, a filament, and a temperature.

5. The method in claim 1, further comprising:
extruding one or more test extrusion patterns having a test velocity profile onto a print bed, and
analyzing the test extrusion pattern, wherein the analysis of the one or more test extrusion patterns is used to calculate K_{c}.

6. The method of claim 5, wherein determining the extruder compensation factor is determining by a user.

7. The method of claim 5, wherein determining the extruder compensation factor is determining by computer vision.

8. The method of claim 7, wherein analysis of the one or more test extrusion patterns comprises capturing an image of the test extrusion.

9. The method of claim 8, wherein the image of the one or more test extrusion patterns is analyzed by a computer algorithm to define quality based on the profile of the test extrusion.

10. The method of claim 8, wherein the analysis of the one or more test extrusion patterns is an automated process.

11. The method of claim 1, wherein the corrected extruder velocity is calculated by a processor component.

12. The method of claim 1, wherein the extruder maximum capability is determined by the hardware parameters of the 3D printer.

13. The method of claim 1, wherein the extruder component further comprises a heater element.

14. The method of claim 5, wherein the one or more test extrusion patterns are each “L”-shaped patterns, angled patterns, or grid patterns.

15. The method of claim 5, wherein the one or more test extrusion patterns are a straight line where part of the line is printed at one speed followed by printing at a second speed.

16. The method of claim 5, wherein the one or more test extrusion patterns are scattered over a substantial portion of the print bed.

17. A method comprising:
causing one or more test extrusion patterns to extrude from a 3D printer nozzle, wherein the one or more test extrusion patterns are extruded at a plurality of speeds and a plurality of accelerations,
analyzing the one or more test extrusion patterns with computer vision,
determining which speed(s) and acceleration(s) were successful and which speed(s)and acceleration(s) exceeded the ability of the extruder motor to cause a an extrusion within the parameters necessary for a printing,
defining a maximum successful extrusion speed and a maximum successful extrusion acceleration as the fastest speed and fastest acceleration that does not exceed the ability of the extruder motor, and
using the maximum successful extrusion speed and the maximum successful extrusion acceleration to limit the speed and acceleration of the extruder.

18. The method of claim 17, wherein the test extrusion patterns are extruded at speeds and accelerations that are increasing.

19. The method of claim 18, wherein a test extrusion pattern is extruded at a speed and/or an acceleration that is expected to be above the speed and/or acceleration at which the extruder can extrude.

20. A method comprising:
causing one or more test extrusion patterns to extrude from a 3D printer nozzle in a first direction,
causing one or more test extrusion patterns to extrude from a 3D printer nozzle in a second direction that is substantially opposite from the first direction, along an axis and where each pattern ends with a visual mark,
analyzing the one or more test extrusion patterns with computer vision,
determining if backlash is causing the marks to have not be at the commanded position and the distance of error in these marks can be saved as a backlash distance for said axis,
wherein this measured backlash distance can be corrected for during normal printing.
